(19) United States
(12) Patent Application Publication
(10) Pub. No.: US 2008/0183810 A1
(43) Pub. Date: Jul. 31, 2008

(54) DISTRIBUTED FORUM

(76) Inventor: Benjamin F. RUEDLINGER, Winchester, MA (US)

Correspondence Address: STRATEGIC PATENTS P.C.., C/O PORTFOLIOIP, P.O. BOX 52050, MINNEAPOLIS, MN, 55402, US

(21) Appl. No.: 12/020,387

(22) Filed: Jan. 25, 2008

Related U.S. Application Data
(60) Provisional application No. 60/886,641, filed on Jan. 25, 2007.
(60) Provisional application No. 60/897,619, filed on Jan. 26, 2007.

(51) Int. Cl. G06F 15/16

(52) U.S. Cl. 709/203

(57) ABSTRACT

A forum participation technique enables users to participate in postings and discussions directly to a blog from a plurality of websites. The technique allows an administrator to enhance a webpage by adding to it an in-page access to the blog. The technique also enables two-way communication between users of webpages having the in-page access. In all, the forum participation technique increases the distribution of a blog by making the blog available on a plurality of websites. Moreover, by enabling the administrators to incorporate interactive, remote blogs into a website, forum participation technique provides administrators with a way of expanding and enhancing web-community interactions.

### RELATED APPLICATIONS

This application claims the benefit of the following commonly-owned U.S. Provisional Patent Applications, each of which is incorporated by reference herein in its entirety: U.S. App. No. 60/886,641 filed on Jan. 25, 2007; and U.S. App. No. 60/897,619 filed on Jan. 26, 2007.

### BACKGROUND

1. Field

The invention relates to web-based discussion groups using a distributed forum.

2. Description of the Related Art

In general, a web-based forum is any discussion group accessible through the web, where users submit postings for other users to read. Postings are electronic messages sent into the forum from sources such as a newsgroup or a blog, and as other users read the postings, they are free to respond, resulting in an ongoing group discussion. Forums can be either time-coincident discussions, such as chat rooms, or forums that do not require the participants to be present at the same time, such as a blog. Blog type forums, which require messages to be stored and manipulated, have been traditionally located on a particular website, and users have had to go to that particular website in order to participate in postings and discussions.

There remains a need for a forum participation technique that enables users to participate in postings and discussions directly to a blog from a plurality of websites.

### SUMMARY

A forum participation technique enables users to participate in postings and discussions directly to a blog from a plurality of websites. The technique allows an administrator to enhance a webpage by adding to it an in-page access to the blog. The technique also enables two-way communication between users of webpages having the in-page access. In all, the forum participation technique increases the distribution of a blog by making the blog available on a plurality of websites. Moreover, by enabling the administrators to incorporate interactive, remote blogs into a website, forum participation technique provides administrators with a way of expanding and enhancing web-community interactions.

In one aspect, a method of communicating that is disclosed herein includes receiving first web content from servers on a network; transmitting the first web content to a plurality of client applications running in a plurality of webpages, substantially all of the webpages being under different administrative control from one another; receiving second web content from at least some of the plurality of clients; and transmitting the second web content to at least some of the servers on the network. The web content may be grouped into discussion threads. The web content may be of at least one service. The service may be a blog. The method of communicating may include transmitting a plurality of instances of computer code, wherein each of the instances, when processed, provides one of the clients. The computer code, when processed, may provide a blogging application. The computer code, when processed, may provide a web browser. The computer code, when processed, may provide an instant messaging forum.

In one aspect, a distributed forum platform that is disclosed herein includes a first input adapted to receive first web content from servers on a network; a first output adapted to transmit the first web content to a plurality of client applications running in a plurality of webpages, substantially all of the webpages being under different administrative control from one another; a second input adapted to receive second web content from at least some of the plurality of clients; and a second output adapted to transmit the second web content to at least some of the servers on the network. The web content may be grouped into discussion threads. The web content may include at least one service. The service may be a blog. The distributed forum platform may include a third output adapted to transmit a plurality of instances of computer code, wherein each of the plurality of instances, when processed, provides one of the clients. The computer code, when processed, may provide a blogging application. The computer code, when processed, may provide a web browser. The computer code, when processed, may provide an instant messaging forum.

These and other systems, methods, objects, features, and advantages of the present invention will be apparent to those skilled in the art from the following detailed description of the preferred embodiment and the drawings. All documents mentioned herein are hereby incorporated in their entirety by reference.

### BRIEF DESCRIPTION OF THE FIGURES

The invention and the following detailed description of certain embodiments thereof may be understood by reference to the following figures:

FIG. 1 depicts a block diagram of the distributed forum platform.

FIG. 2 provides an example of a forum discussion thread.

FIG. 3 provides an example of a user window depicting a discussion thread embedded into a user's blog.

FIG. 4 provides an example of a forum-level window embedded into a user's blog.

FIG. 5 shows a thread-level access component.

FIG. 6 shows a slim-line forum access component.

FIG. 7 shows an application-level forum access component.

### DETAILED DESCRIPTION

A personal website, such as blog, allows its owner to initiate a public discussion thread by posting web content, such as a blog post. Visitors to the website may read the blog post and, in some cases, post responses. These responses may appear on the personal website, providing future visitors with the opportunity to see the initial blog post plus any and all responses.

The owner of the personal website may himself visit or frequent another website. That website may contain one or more discussion threads that the owner finds relevant to his personal website. The owner may want to share these discussion threads with his personal website's visitors. However, the owner may not want to direct the visitors away from his personal website.

The forum participation techniques described herein may enable the owner of the personal website to share a discussion thread at another website without directing visitors to that website. Software for accessing the discussion thread may be included in plurality personal websites by their respective owners. When this happens, a distributed forum may arise in which a plurality of visitors to a plurality of personal websites may communicate via a single discussion thread hosted at a single personal website.

Throughout this disclosure references to a personal website should be understood to include any and all websites, including commercial websites. Moreover, references to an owner of a personal website should be understood to include any and all owners, including corporate owners or other non-human entities. The word “owner” should be read as “owner, administrator, or the like”.

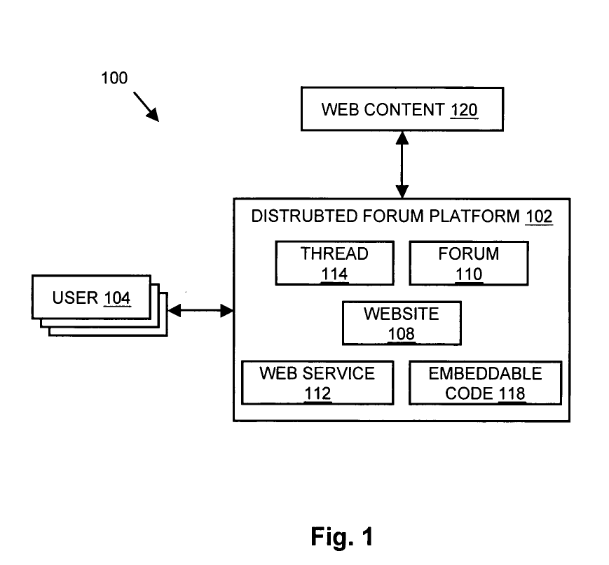

FIG. 1 shows a block diagram 100 of the components of a distributed forum platform 102 and its interactions with users 104 and web content 120. These components and interactions include the distributed forum platform 102, the users 104, a website 108, a forum 110, a web service 112, a thread 114, an embeddable code 118, web content 120, and so on.

The distributed forum platform 102 may be associated with a website 108 that users 104 may access. From this website 108 users 104 may view the forum 110; create a forum 110; access the web service 112, and so on.

The users 104 may include owners of personal websites, visitors to personal websites, and so on.

The website 108 may be a personal website, corporate website, or the like. The website 108 may contain one or more forums 110, each of which may contain one or more threads 114. The forums 110 and the threads 114 may constitute web content 120. The website 108 may be hosted on one or more web servers and may be available via the Internet at one or more URLs.

The forum 110 may provide an online venue in which people can synchronously or asynchronously communicate. In embodiments, the forum 110 may be a blog, chat room, or the like. The forum may be encoded in HTML, XHTML, XML, or the like. The forum 110 may be hosted on a web server and may be available via the Internet at one or more URLs. Forums 110 managed within the distributed forum platform 102 may be created from a plurality of text sources, and may be supplemented with rich media, such as podcasts, video, mainstream media, and the like. It will be understood that a variety of embodiments of the forum 110 are possible.

The web service 112 may provide users 104 with content that is associated with the forum 110, the thread 114, the web content 120, or the like. Without limitation, the web service 112 may be an advertising service that provides, to users 104, advertisements that are related to the forum 110, thread 114, and/or web content that the users 104 are receiving. For example, a user 104 may be viewing a thread 114 that relates to web hosting. In this example, the web service 112 may provide to the user 104 one or more pay-per-click advertisements that relate to web hosting. It will be understood that a variety of embodiments of the web service 112 are possible.

The thread 114 may be a threaded discussion including a post followed by any and all number of comments. The comments may be nested. That is, there may be comments to comments as well as comments to the post. Alternatively or additionally, the thread may be a collection of web content 120 that is related by topic. The topic may be encoded with a tag, which may be user-supplied and/or machine-generated. The thread 114 may be organized chronologically, alphabetically, according to user feedback, and so on. It will be understood that a variety of embodiments of the thread 114 are possible.

The embeddable code 118 may include software providing direct access to the forum 110, thread 114, and/or web content 120 at the website 108. The software may be embedded or loaded into client-side software, such as and without limitation the user's 104 blog software, the user's 104 web browser, or the like. The embeddable code 118 may be installed, linked, and/or dynamically loaded in client-side software. Alternatively or additionally, client-side software may download, interpret, and/or execute the embedded software at runtime.

The owner of a personal website may provide or link to the embeddable code 118 from the personal website. A user 104 who visit the website 108 may ally receive the embeddable code 118. The software may include JavaScript, Flash, XSLT, HTML, or the like. It will be understood that the software may include a variety of software, not just blog software. It will be understood that a variety of embodiments of the software are possible.

The web content 120 may include any content provided via the World Wide Web. For example and without limitation, the web content 120 may include images, video, blog posts, comments, trackbacks, pingbacks, email, and the like. A plurality of websites (including the website 108 and remote websites) may provide the web content 120. It will be understood that a variety of web content 120 is possible.

Users 104 may communicate with the distributed forum platform 102 as a client from anywhere on the web. The user 104 (via the client) may communicate with the website 108, forum 110, thread 114, web content 120, or the like. The client may include the embeddable code 118, which may at least in part enable the aforementioned communication.

In general, the user 104 may continue to interact with the forum 102 and related web content 120 without remaining at a particular website. The user 104 may be provided with embeddable code 118, which he may put into his personal webpage. When a visitor 104 views the personal webpage, that visitor's client application processes the embeddable code 118.

A forum participation technique includes receiving first discussion content from servers on a network. The arrow from the web content 120 to the distributed forum platform 102 depicts this. Then, the distributed form platform 102 transmits the first discussion content a plurality of client applications in a plurality of webpages. The arrow from the distributed forum platform 102 to the users 104 depicts this. In response to the web content 120, some or all of the users 104 may post a comment, response, or the like. As shown by the arrow from the users 104 to the distributed forum platform 102, the comment, response, or the like may be received, at the distributed forum platform 102 and from the users' 104 clients, as second discussion content. The distributed forum platform 102 may transmit the second discussion content to at least some servers that are hosting the web content 120. The arrow from the distributed forum platform 102 to the web content 120 shows this.

The forum participation technique my include distributing instances of the embeddable code 118 to some or all of the users 104. The embeddable code 118, when processed, may provide a client-side application that implements some or all of the forum participation technique.

The distributed forum platform 102 may implement the forum participation technique. The distributed forum platform 102 may include a first input adapted to receive the first discussion content. The distributed forum platform 102 may include a second input that is adapted to transmit the first discussion content to a plurality of user 104 client applications. These client applications may be running in a plurality of web pages, substantially all of which may have different owners from one another. The distributed forum platform 102 may include a second output adapted to transmit the second discussion content to at least some servers hosting the web content 120. The distributed forum platform 102 may include a third output adapted to transmit a plurality of instances of the embeddable code 118 to users' 104 client applications. It will be understood that a variety of embodiments of the distributed forum platform 102 are possible.

The distributed forum platform 102 described above provides numerous feature and advantages not present in the prior art. By way of example, the distributed forum platform 102 allows users 104 on multiple websites 108 and blogs to participate in a single discussion, with users 104 posting replies directly from their own website 108, or any site on the web. The distributed forum platform 102 provides user 104 links back to its source content, which gets real estate on websites 108 and blogs from all over the web. Allows users on multiple websites/blogs to participate in a single discussion

In one aspect, the content of a distributed discussion thread may provide links to content of the distributed forum host, or to content providers, or some combination of these. Each forum may expand its presence by obtaining web page space on websites/blogs all over the web. In addition to providing enhanced advertising revenue opportunities for content creators, this approach can improve search placement by incorporating feedback from users across the web.

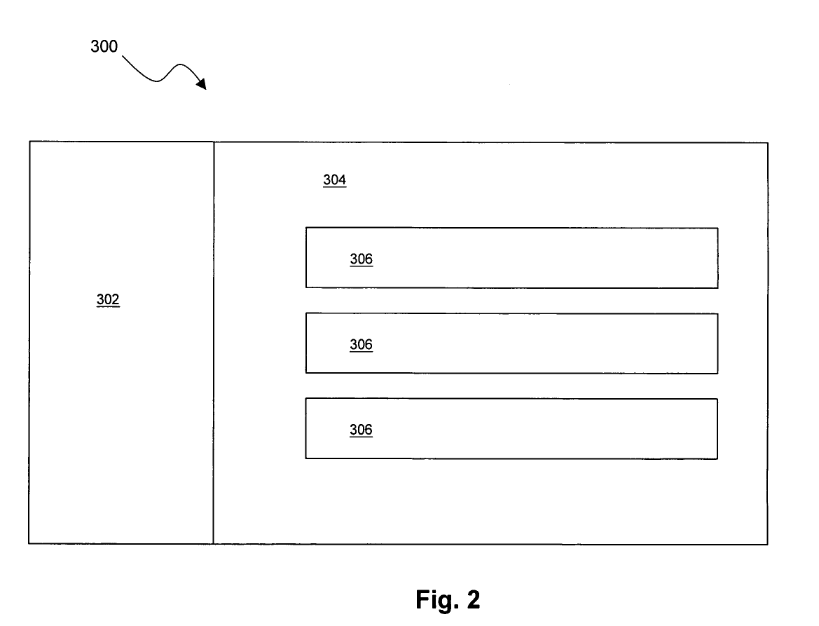

FIG. 2 shows a remote discussion thread hosted at a distributed forum platform. In general, the user interface 300 provided by the forum may include a toolbar 302 and one or more discussion threads 304, each including a plurality of posts 306 or other items. A user 104, visiting the website 108 of the distributed forum platform 102 for the first time, may utilize webservices to establish a connection to their site. The user 104 may then pull content windows up in their own site. The user 104 may choose to connect only to an individual discussion thread 304, like the one shown in the thread illustration 300 of FIG. 2. Note that initially this discussion thread 304 comes from a third-party forum, and includes items 306 relating to a single discussion occurring within that forum.

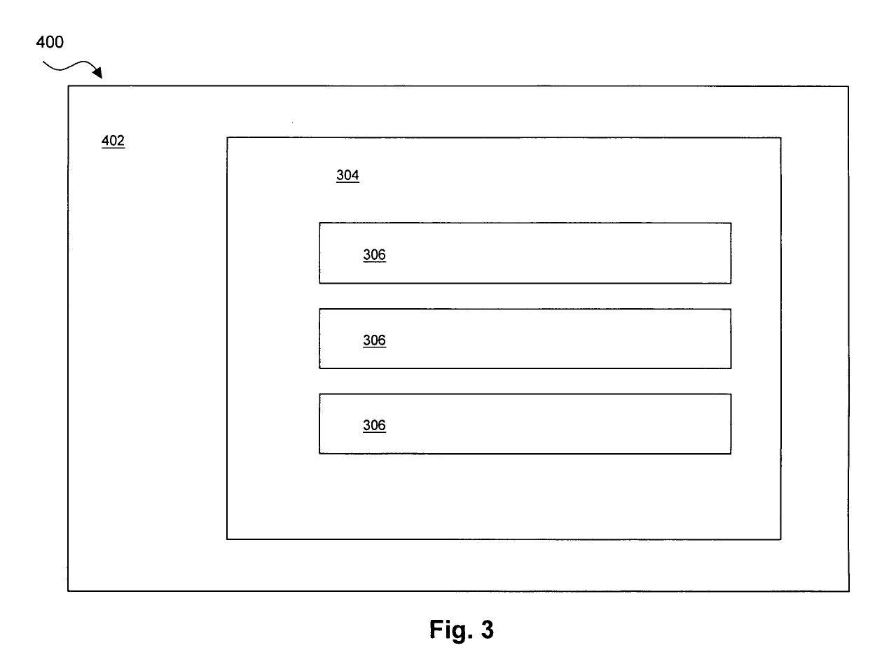

FIG. 3 shows a different website 400, such as a weblog, containing code (such as Flash media, JavaScript, or the like) allowing a user to embed the discussion thread 304 of FIG. 2 within the user's own content 402. The user 104 may wish to allow this discussion thread 304 to embed into their own website 108, and permit viewers of their content 402 to participate in the remote discussion, as shown in embedded thread illustration of FIG. 3.

The embedded thread 306 may include a number of tools to support end user interaction with the discussion thread. For example, the embedded thread 306 may provide a scrollbar for navigating through thread content without disturbing the end user's window or the provider's content 402. The embedded thread may add “reply” or “post” tools that function, from the user's perspective, in the same manner as conventional web communication systems. It will be understood that while the behavior may be similar for and end user, that operationally the behavior is significantly different because each reply or other communication is transmitted through the distribute forum platform, which may in turn periodically update content within the embedded thread 306. Other tools such as a link to the distributed forum platform host, or help tools, option menus, and the like may similarly be included to enhance end user and content provider usage of the message thread. In order to further improve independent portability of the message thread 306, the embedded thread on the content provider's site may include a button or other tool that permits end user's to port the embedded thread to additional web content, such as a web site or weblog hosted by the end user.

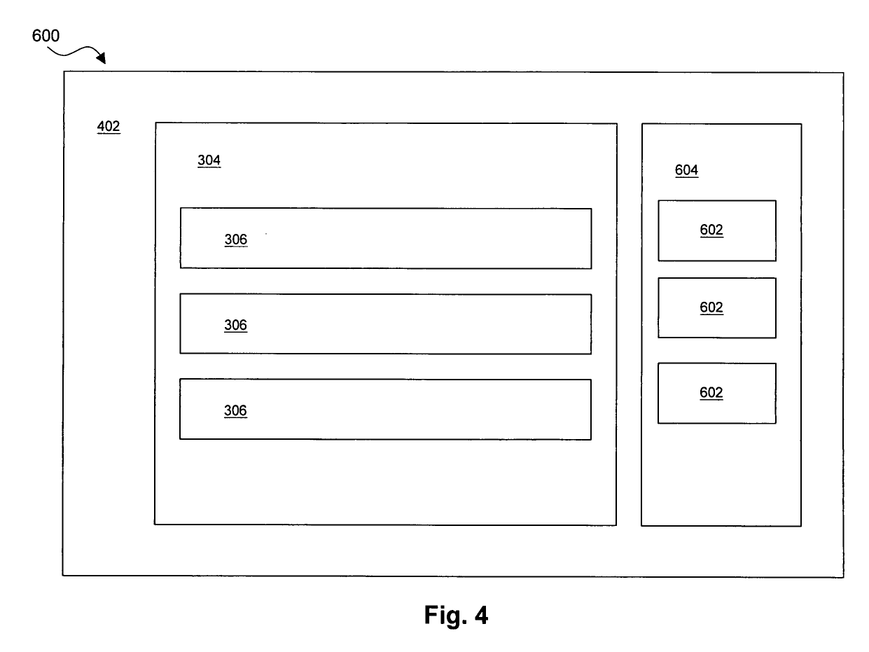

FIG. 4 shows another example of web content incorporated discussions from a distributed forum. In particular, users 104 may embed a forum-level access into the content 402 of their website 600, where the various discussion threads 602 for the forum topic are listed in a topic window 604. The user 104 may choose to use, or provide to end users, application-level access to the forum, which combines both the thread-level window 304 and forum-level window 604, such as within a multi-pane window embedded into the web content 600. These components may be added using tools within the forum website, or using suitable coding to add appropriate external references to a suitably enabled web page or other content.

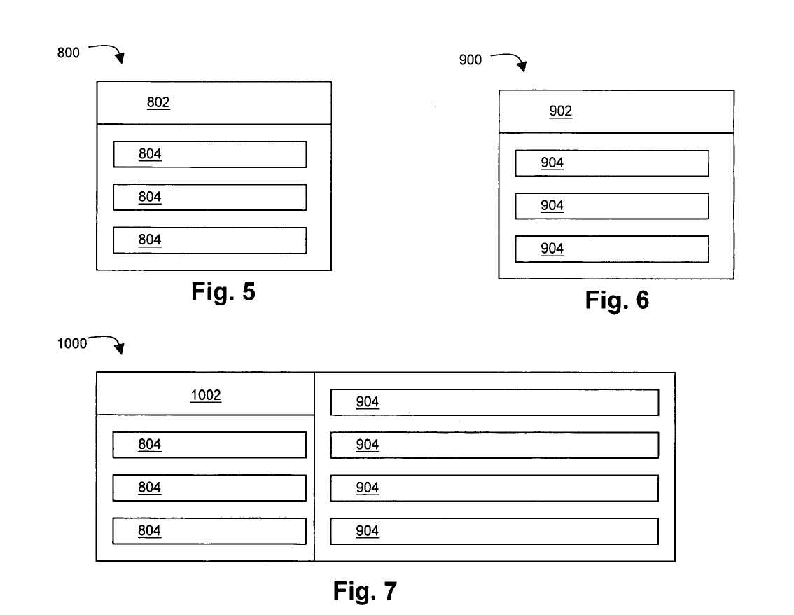

In general, the forum may provide a number of different formats for presenting remotely hosted content. FIG. 5 shows a thread-level component 800 including a title 802 of a discussion thread and a number of items 804 within the discussion thread. FIG. 6 shows a slim-line forum access component 900 including a title 902 of a forum and a listing of various discussion topics 904 hosted by that forum. FIG. 7 shows an application-level component 1000 that provides an integrated view and controls for a number of different discussion threads 1002, and for one or more selected once of the discussion threads 1002, a number of individual posts 904 within that thread 1002. In addition to providing a layout and source content, each component may provide any number of additional tools such as those generally described above, to assist end users in both interacting with the content and/or re-distributing the content or otherwise incorporating the content into additional web content, all while maintaining end user connections to the forum hosting the original discussion (or other content). Thus the distributed platform may provide varying degrees of integration from which a web page or other content designer may select the most appropriate format and tools. For example, these tools cooperate to provide users 104 and bloggers with a robust forum a comment toolset for flexible integration of content from the forum.

In one aspect, advertising may also be added in order to produce a revenue stream that may be allocate as appropriate among a web site displaying the content, the distributed forum platform, and an original content source. Advertisements may be placed within posts, title bar areas, or any other region within the layouts shown, for example, in FIGS. 5-7.

The user interfaces described above may be implemented as user-side client application, or as a connection to an appropriate server, which may be hosted at a web content provider that is providing the web page (or other content), or at the distributed forum platform. In another aspect, elements of the interface may be authorized and enabled by original content sources through suitable adaptations to the original content server. A management configuration interface may be located, for example, at the website 108 of the distributed forum platform 102. A user 104 that starts a forum may specify what its focus is to be, who can post to it, whether other web sites can participate at that forum, and the like. These options may be configured through the management interface to the distributed forum platform 102 website 108. In one embodiment, the client interface may be implemented as a Flash-object embedded within a web page that connects to a particular thread on a forum. This technique or any other suitable web technology may be employed to allow users 104 to hit a reply button or otherwise interact with discussion content without navigating away from a particular page where the distributed content is being displayed. Forum-level and application-level interfaces may be instantiated in a similar way.

In a connection to a user 104 site such as a blog, the blogger writes and maintains the blog. If the blogger wants to add the blogger's own forum, or tap into an existing forum 110, or add a forum capability to its blog, all the blogger has to do is copy the HTML code 118 and put it on their page for their users 104 to have access to the forum/discussion. The capabilities now show up on its blog to read. When a user 104 comes to the blog web site, the user 104 now sees a list of threads 114 on the forum 110. Clicking on one of the threads 114, the discussion appears, and the user 104 may now hit the reply button in order to join in the thread's 114 discussion. The user's 104 reply is now accessible to any person reading the forum 110, anywhere on the web.

The distributed forum platform 102 enables a user 104 to cross communicate with other users 104, while not leaving the user's 104 own website 108, MySpace page, blog, or the like. It will be understood that while the preceding discussion has emphasized weblog content and discussion forums, the concepts disclosed herein may be readily applied to chat rooms, bulletin boards, auctions, interactive games, or any other communication or interaction medium supported through a data network such as the Internet. All such variations as would be apparent to one of ordinary skill in the art are intended to fall within the scope of this disclosure.

The elements depicted in flow charts and block diagrams throughout the figures imply logical boundaries between the elements. However, according to software or hardware engineering practices, the depicted elements and the functions thereof may be implemented as parts of a monolithic software structure, as standalone software modules, or as modules that employ external routines, code, services, and so forth, or any combination of these, and all such implementations are within the scope of the present disclosure. Thus, while the foregoing drawings and description set forth functional aspects of the disclosed systems, no particular arrangement of software for implementing these functional aspects should be inferred from these descriptions unless explicitly stated or otherwise clear from the context.

Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods or processes described above, and steps thereof, may be realized in hardware, software, or any combination of these suitable for a particular application. The hardware may include a general-purpose computer and/or dedicated computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as computer executable code created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software. All such permutations and combinations are intended to fall within the scope of the present disclosure.

While the invention has been disclosed in connection with the preferred embodiments shown and described in detail, various modifications and improvements thereon will become readily apparent to those skilled in the art, and are intended to fall within the scope of this disclosure. Accordingly, the spirit and scope of the present invention is not to be limited by the foregoing examples, but is to be understood in the broadest sense allowable by law.

What is claimed is:

1. A method of communicating, comprising:
receiving first web content from a plurality of servers on a network;
transmitting the first web content to a plurality of client applications running in a plurality of webpages on a plurality of client devices;
receiving second web content from at least one of the plurality of client applications; and
transmitting the second web content to at least one of the plurality of servers on the network.

2. The method of claim 1 wherein receiving second web content includes receiving a plurality of web content items from two or more of the plurality of client applications.

3. The method of claim 1 wherein transmitting the second web content includes transmitting the second web content to two or more of the plurality of servers.

4. The method of communicating of claim 1 wherein the first web content and the second web content are grouped into discussion threads.

5. The method of claim 1 wherein the first web content is obtained from a service.

6. The method of claim 5 wherein the service is a weblog.

7. The method of claim 1 further comprising transmitting a plurality of instances of computer code, wherein each of the instances, when processed, provides one of the client applications.

8. The method of claim 7 wherein the computer code, when processed, provides a blogging application.

9. The method of claim 7 wherein the computer code, when processed, provides a web browser.

10. The method of claim 7 wherein the computer code, when processed, provides an instant messaging forum.

11. A distributed forum platform, comprising:
a first input adapted to receive first web content from a plurality of servers on a network;
a first output adapted to transmit the first web content to a plurality of client applications running in a plurality of webpages on a plurality of client devices;
a second input adapted to receive second web content from at least one of the plurality of client applications; and
a second output adapted to transmit the second web content to at least one of the plurality of servers on the network.

12. The distributed forum platform of claim 11 wherein the second input is adapted to receive second web content from two or more of the plurality of client applications.

13. The distributed forum platform of claim 11 wherein the second output is adapted to transmit the second web content to two or more of the plurality of servers.

14. The distributed forum platform of claim 11 wherein at least one of the first web content and the second web content is grouped into discussion threads.

15. The distributed forum platform of claim 11 wherein the first web content includes at least one service.

16. The distributed forum platform of claim 15 wherein the at least one service is a blog.

17. The distributed forum platform of claim 11 further comprising a third output adapted to transmit a plurality of instances of computer code, wherein each of the plurality of instances, when processed, provides one of the client applications.

18. The distributed forum platform of claim 17 wherein the computer code, when processed, provides a blogging application.

19. The distributed forum platform of claim 17 wherein the computer code, when processed, provides a web browser.

20. The distributed forum platform of claim 17 wherein the computer code, when processed, provides an instant messaging forum.
